(19) United States
(12) Patent Application Publication
(10) Pub. No.: US 2018/0347743 A1
(43) Pub. Date: Dec. 6, 2018

(54) MULTIFUNCTIONAL AND SPECIAL CANTILEVER HOLDER STRUCTURE

(71) Applicant: Zhongshan Nikow Precision Industrial Co.,Ltd., Guangdong (CN)

(72) Inventor: Yongjun PIAO, Guangdong (CN)

(21) Appl. No.: 15/578,552

(22) PCT Filed: Sep. 8, 2017
(86) PCT No.: PCT/CN2017/101057

§ 371 Date: Nov. 30, 2017

(30) Foreign Application Priority Data
Dec. 26, 2016 (CN) 201611213915.6

(51) Int. Cl. F16M 11/12; F16M 11/24; G03B 17/56

(52) U.S. Cl. CPC F16M 11/126; G03B 17/561; F16M 11/242

(57) ABSTRACT

A multifunctional and special cantilever holder structure, comprising a transfer platform, a connecting structure, a chassis, a tripod stand, and an inclined pillar forming a 90-degree angle with respect to a horizontal plane of the chassis, wherein the inclined pillar is able to rotate down by 190 degrees as a clamping wrench is opened, and the inclined pillar stands upside down between two foot pins of the tripod stand.

### TECHNICAL FIELD

The present invention relates to a photographic auxiliary device, and especially relates to a multifunctional and special cantilever holder structure.

### BACKGROUND

A tripod cantilever holder is a supporting device for installing and fixing a photographic device. At present, due to the design defects in the prior art, there are troubles on combination, installation, disassembly and carrying of the tripod. Therefore, a multifunctional and special cantilever holder structure is invented.

### SUMMARY OF THE INVENTION

The invention provides a multifunctional and special cantilever holder structure which does not need needing combination, installation and disassembly from the tripod, and is very convenient to carry more particularly. In order to achieve the objects above, the following solutions are adopted in the invention.

A multifunctional and special cantilever holder structure comprises an inclined pillar, a transfer platform, a turning rotary knob and a chassis. The transfer platform is arranged on one side end of the inclined pillar, and is applicable to install and fix a photographic device, wherein the other side end of the inclined pillar is provided with the turning rotary knob. The chassis is arranged at the side end of a molding opening of a connecting structure of the inclined pillar for supporting the inclined pillar. A connecting screw is arranged on the downside surface of the chassis. And the connecting screw inserts through the tripod stand to be connected with a ring nut, and a stand turning wrench controls the chassis to rotate left and right by 360 degrees.

The connecting structure of the inclined pillar comprises the molding opening, a left panel, a right panel, a left screw, a right screw, a screw rod, a flat gasket, a clamping wrench, a left hole, a right hole, and a connecting pin, wherein the upper portion of the molding opening is provided with a vertical opening, the side end of the chassis is provided with a molding convex plate which comprises a positioning opening and a connecting hole. The left hole is closely connected to the right hole by the connecting pin inserting through the right hole, the connecting hole and the left hole. An external thread of the screw rod is connected and fixed with an internal thread of the clamping wrench. The other end of the screw rod inserts through the flat gasket, the right screw and the positioning opening to be connected with the left screw in a threaded manner. The molding opening of the inclined pillar is mutually matched with the molding convex plate at the side end of the chassis. The clamping wrench is rotated to clamp and lock the molding convex plate by the left panel and the right panel. The inclined pillar forms a 90-degree angle with respect to the horizontal plane of the chassis. The inclined pillar rotates down by 190 degrees when the clamping wrench is opened, and the inclined pillar stands upside down between two foot pins under the tripod stand.

### BRIEF DESCRIPTION OF THE DRAWINGS

FIG. 1 shows an exploded view of a multifunctional and special cantilever holder structure;

FIG. 2 is a schematic diagram of an inclined pillar after standing upside down; and

FIG. 3 is a sectional view along A-A in FIG. 1;

In FIGS. 1-3, 1 refers to inclined pillar, 2 refers to chassis, 3 refers to tripod stand, 1-1 refers to connecting structure, 11 refers to transfer platform, 12 refers to turning rotary knob, 13 refers to vertical opening, 14-1 refers to left panel, 14-2 refers to right panel, 15 refers to molding opening, 16-1 refers to left screw, 16-2 refers to right screw, 17 refers to screw rod, 18-1 refers to left hole, 18-2 refers to right hole, 19 refers to flat gasket, 101 refers to clamping wrench, 102 refers to connecting pin, 21 refers to molding convex plate, 22 refers to positioning opening, 23 refers to connecting hole, 24 refers to connecting screw, 31 refers to ring nut, 32 refers to stand turning wrench, and 33 refers to foot pin.

### DETAILED DESCRIPTION OF THE EMBODIMENTS

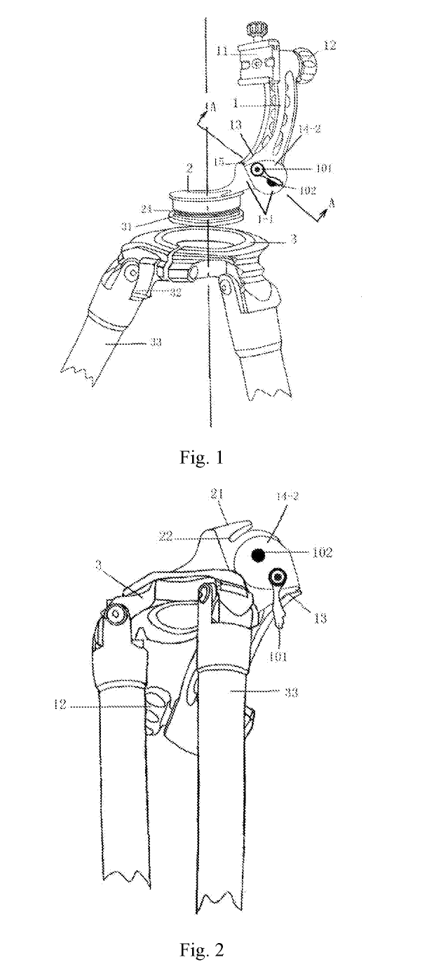

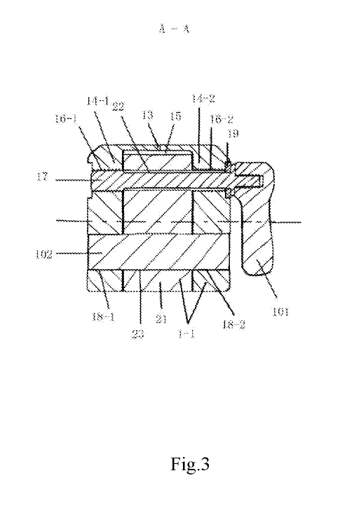

The invention will be further described in details hereinafter with reference to FIG. 1, FIG. 2 and FIG. 3.

A multifunctional and special cantilever holder structure of the invention comprises an inclined pillar 1, a transfer platform 11, a turning rotary knob 12 and a chassis 2. The transfer platform 11 is arranged on one side end of the inclined pillar 1, and is applicable to install and fix a photographic device, wherein the other side end of the inclined pillar 1 is provided with the turning rotary knob 12. The chassis 2 is arranged at the side end of a molding opening 15 of a connecting structure 1-1 of the inclined pillar 1 for supporting the inclined pillar 1. A connecting screw 24 is arranged on the downside surface of the chassis 2, and inserts through a tripod stand 3 to be connected with a ring nut 31. And a stand turning wrench 32 controls the chassis 2 to rotate left and right by 360 degrees.

The connecting structure 1-1 of the inclined pillar 1 comprises the molding opening 15, a left panel 14-1, a right panel 14-2, a left screw 16-1, a right screw 16-2, a screw rod 17, a flat gasket 19, a clamping wrench 101, a left hole 18-1, a right hole 18-2, and a connecting pin 102, wherein the upper portion of the molding opening 15 is provided with a vertical opening 13, the side end of the chassis 2 is provided with a molding convex plate 21 which comprises a positioning opening 22 and a connecting hole 23. The left hole 18-1 is closely connected to the right hole 18-2 by the connecting pin 102 inserting through the right hole 18-2, the connecting hole 102 and the left hole 18-1. An external thread of the screw rod 17 is connected and fixed with an internal thread of the clamping wrench 101. The other end of the screw rod 17 inserts through the flat gasket 19, the right screw 16-2 and the positioning opening 22 to be connected with the left screw 16-1 in a threaded manner. The molding opening 15 of the inclined pillar 1 is matched with the molding convex plate 21 at the side end of the chassis 2, the clamping wrench 101 is rotated to clamp and lock the molding convex plate 21 by the left panel 14-1 and the right panel 14-2. The inclined pillar 1 forms a 90-degree angle at a horizontal plane of the chassis 2. The inclined pillar 1 rotates down by 190 degrees when the clamping wrench 101 is opened, and the inclined pillar 1 stands upside down between two foot pins 33 of the tripod stand 3.

The invention has the characteristics that: the inclined pillar forms a 90-degree angle with respect to the horizontal plane of the chassis, the inclined pillar rotates down by 190 degrees when the clamping wrench is opened, and the inclined pillar stands upside down between two foot pins under the tripod stand It does not need to combine, install and disassemble the cantilever holder from the tripod, thus thoroughly solving the troubles of combination, installation, disassembly and carrying, so as to increase the use value of the cantilever holder.

The description above only includes embodiments of the invention, but is not intended to limit the protection scope. Any replacement or variant made by those skilled in the art without going through any creative work in the technical scope disclosed by the invention shall fall within the protection scope of the invention. Therefore, the protection scope of the invention shall be subject to the protection scope limited by the claims.

1. A multifunctional and special cantilever holder structure, comprising
a transfer platform,
a connecting structure,
a chassis,
a tripod stand, and
an inclined pillar forming a 90-degree angle with respect to a horizontal plane of the chassis, wherein the inclined pillar is able to rotate down by 190 degrees as a clamping wrench is opened, and the inclined pillar stands upside down between two foot pins of the tripod stand.

2. The multifunctional and special cantilever holder structure according to claim 1, wherein the inclined pillar having a connecting structure comprising a molding opening, a left panel, a right panel, a left screw, a right screw, a screw rod, a flat gasket, a clamping wrench, a left hole, a right hole, a connecting pin, a vertical opening, a molding convex plate, a positioning opening and a connecting hole, and wherein the left hole is closely connected to the right hole by the connecting pin inserting through the right hole, the connecting hole and the left hole.

3. The multifunctional and special cantilever holder structure according to claim 2, wherein: an external thread of the screw rod is connected and fixed with an internal thread of the clamping wrench, the other end of the screw rod inserts through the flat gasket, the right screw and the positioning opening to be connected with the left screw in a threaded manner, the molding opening of the inclined pillar is matched with the molding convex plate at the side end of the chassis, and the clamping wrench is rotated to clamp and lock the molding convex plate by the left panel and the right panel.

4. The multifunctional and special cantilever holder structure according to claim 1, wherein: the chassis comprises a connecting screw and a ring nut; the chassis is arranged at one side end of the molding opening of the connecting structure of the inclined pillar for supporting the inclined pillar, the connecting screw on the downside surface of the chassis inserts through the tripod stand to be connected with the ring nut, and a stand turning wrench controls the chassis to rotate left and right by 360 degrees.

5. The multifunctional and special cantilever holder structure according to claim 1, wherein: the inclined pillar forms a 90-degree angle with respect to the horizontal plane of the chassis, the inclined pillar rotates down by 190 degrees as the clamping wrench is opened, and the inclined pillar stands upside down between two foot pins of the tripod stand.

6. The multifunctional and special cantilever holder structure according to claim 2, wherein: the vertical opening is arranged on an upper portion of the molding opening of the connecting structure of the inclined pillar to adjust the tightness of the left panel and the right panel.
